(19) United States
(12) Patent Application Publication
(10) Pub. No.: US 2006/0047620 A1
(43) Pub. Date: Mar. 2, 2006

(54) Method for monitoring changes to an electronic document having a primary predefined purpose

(75) Inventors: Michael J. Branson, Rochester, MN (US); Gregory R. Hintermeister, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/926,933

(22) Filed: Aug. 26, 2004

(51) Int. Cl. G06F 12/00

(52) U.S. Cl. 707/1

(57) ABSTRACT

A computer implemented method for monitoring changes to an electronic document having a primary predefined purpose is provided. In one embodiment, the method comprises accessing an attribute of the electronic document, wherein the attribute is specifically and solely configured to reflect the primary predefined purpose of the electronic document, determining whether the attribute indicates that a status of the primary predefined purpose has changed, and displaying a change notification when the status of the primary predefined purpose has changed. The determining step may comprise storing a first status of the predefined purpose of the electronic document and a first associated time stamp, receiving a second status of the predefined purpose and a second associated time stamp and comparing the first status to the second status.

### BACKGROUND OF THE INVENTION

1. Field of the Invention

The present invention generally relates to a computer implemented method for monitoring changes to an electronic document having a primary predefined purpose, and more particularly, to a computer implemented method for notifying a user of changes to the status of a primary predefined purpose for a document.

2. Description of the Related Art

Current computers systems may be large and complex, having many hardware and software components. Many programs, such as servers, databases, file systems, security programs, system monitors, system services, and other programs, may run concurrently on a computer system. Each system typically tracks the status of each of the servers, databases, file systems, security programs, system monitors, system services, and other programs. Each computer system may also have many hardware devices such as mass storage devices, network communication devices, and system backup devices, each of which is also monitored and managed by the computer system.

Monitoring the behavior and status of every component in a system is an important but time consuming task. Monitoring the system is important because the failure of a single component could cause other portions of the system to fail and may cause the system to lose desired functionality. Monitoring a computer system may be time consuming because of the vast number of hardware and software components contained in the system.

The task of monitoring system behavior may be simplified by a system management program. A system management program may generate separate electronic documents listing the behavior of each of the components within a system. The components may be grouped together in electronic documents according to related functionality. For instance, one electronic document may list the status of all of the web servers on a system while another electronic document may list the status of the network connections for a system. Each electronic document may also contain a link to other electronic documents, creating a hierarchy of electronic documents. For instance, an electronic document listing all of web servers may contain a link to an electronic document for a specific web server which, in turn, may list each task that the specific web server is performing.

The system management program may be made available as a web interface, allowing each of the electronic documents to be accessed across a network using a browser program. This may allow a user of a system management program to remotely manage the system. Thus, a user of the system management program may access information for each aspect of the system by downloading the electronic document listing the components corresponding to that aspect of the system. The user may also use the hierarchy of electronic documents to look at the system from a general level, or the user may drill down into the hierarchy by following links to lower level electronic documents and look at the system at a very specific level.

Despite the efficiencies gained by monitoring a system using a system management program, monitoring a system may still be very time consuming, particularly when remotely managing a system. For instance, each electronic document displayed by the system management program may contain the statuses of many components, which may require a long time to download of the document. Also, since a user of the system management program may not care about each individual component in the document, the user would prefer not to have to download and review the entire document to determine that every component listed on that document is working correctly. For instance, the user may only care about the status of a predefined purpose of the document (also referred to herein as “key intent”) such as whether key components listed on that document are functioning properly. In addition, the user may not care to download the document again if the document is unchanged since the last time the user accessed the document. For instance, the user may only wish to know when there has been a change in the status of the predefined purpose of the document (e.g., when an important component listed on the document has ceased to function properly).

Currently, the user must manually refresh an electronic document to determine if the status of the predefined purpose of that document has changed, which may require the user to download a copy of the entire document which may contain a listing of all of the related components. While the user may only care about a portion of the components on a document, the user must scan the entire list of components to determine if the status of the pertinent components has changed. Also, the user may browse away from a document, moving down the hierarchy of documents to another document. If the status of the original document changes while the user is looking at another document which is lower in the hierarchy, the user may be unaware of the change that has taken place. Currently, the user cannot detect such a change unless the user returns to the original document and downloads the entire listing of components, scans the listing of all of the components and determines the status of the pertinent components, which may or may not have changed since the last time the user viewed the document.

One possible solution to the problem of determining whether there has been a change to the status of a predefined purpose of a document is a program which downloads the entire document and compares the downloaded document to the last/previous version of the document which the user has downloaded, displaying a list of all the changes. This solution is inefficient because the user may not care about every single change in a document (e.g., the user may not care if a small program has started running slowly but may care if a major server has crashed). Also, although the user may only care about a small selection of the components listed in a document, the program still has to download the entire document for comparison, which may be a time-consuming task.

Therefore, there is a need for a method for determining status changes regarding a predefined purpose of an electronic document. More particularly, there is a need for a method for notifying a user of changes to the status of a predefined purpose of an electronic document without requiring the user to download the entire electronic document.

### SUMMARY OF THE INVENTION

Embodiments of the present invention generally provide a method, a computer readable medium and a system for determining status changes regarding a primary predefined purpose of an electronic document. More particularly, embodiments of the present invention generally provide a computer implemented method for notifying a user of changes to the status of a primary predefined purpose of an electronic document without requiring the user to download the entire electronic document.

In one embodiment, the computer implemented method comprises accessing an attribute of the electronic document, wherein the attribute is specifically and solely configured to reflect the primary predefined purpose of the electronic document, determining whether the attribute indicates that a status of the primary predefined purpose has changed, and displaying a change notification when the status of the primary predefined purpose has changed. The determining step may comprise storing a first status of the predefined purpose of the electronic document and a first associated time stamp, receiving a second status of the predefined purpose and a second associated time stamp and comparing the first status to the second status. The method may further comprise querying the electronic document, wherein the second status is received in response to the query. Alternatively, the electronic document may be located on a remote computer, wherein the status of the predefined purpose is determined and provided periodically by the remote computer. The primary predefined purpose of the electronic document may comprise one or more statuses of one or more components listed in the electronic document. The status of the primary predefined purpose of the electronic document may be determined by assessing whether the one or more components listed in the electronic document are functioning. In one embodiment, the respective attribute of the respective electronic document may remain unchanged while one or more parts of the respective electronic document have changed. The attribute may comprise one of a field, a parameter, an HTML tag and an XML tag.

Another embodiment provides a computer implemented method for monitoring changes to a plurality of previously accessed electronic documents, each having a predefined primary purpose attribute, comprising: displaying a hierarchical link representation having a plurality of links corresponding to the plurality of the previously accessed electronic documents, determining whether respective primary predefined purpose attribute of respective previously accessed electronic document has changed, and displaying a change notification with the respective link in the hierarchical link representation when the respective primary predefined purpose attribute has changed for the respective previously accessed electronic document. The hierarchical link representation may comprise a navigational trail. The method may further comprise selecting the respective link in the hierarchical link representation for which the respective primary predefined purpose attribute has changed and displaying an updated version of the respective previously accessed electronic document.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating an exemplary computer system for implementing embodiments of the present invention;

FIG. 2 is a block diagram illustrating an exemplary computer system configured for remote management of another computer system according to one embodiment of the invention;

FIG. 3 is a flow diagram illustrating the process for displaying electronic documents according to one embodiment of the invention;

FIG. 4 is a flow diagram illustrating the process for displaying a change notification according to one embodiment of the invention;

FIG. 5 is a flow diagram illustrating a process for displaying changes to a key intent status of a link according to one embodiment of the invention.

FIG. 6 is a diagram illustrating an exemplary user interface for displaying changes to a status of a predefined purpose of an electronic document in a hierarchy according to one embodiment of the invention; and

FIG. 7 is a diagram illustrating an exemplary user interface for displaying changes to a status of a predefined purpose of an electronic document in a favorites folder according to one embodiment of the invention.

FIG. 8 is a diagram illustrating an exemplary user interface for displaying changes to a status of a predefined purpose of an electronic document in a favorites folder according to another embodiment of the invention.

### DETAILED DESCRIPTION OF THE PREFERRED EMBODIMENTS

Embodiments of the present invention generally provide a method, a computer readable medium and a system for determining status changes regarding a predefined purpose of an electronic document and displaying a change notification to a user.

In general, the routines executed to implement the embodiments of the invention may be part of an operating system or a specific application, component, program, module, object, or sequence of instructions. The computer program according to embodiments of the present invention may comprise a multitude of instructions that may be translated by the native computer into a machine-readable format and hence executable instructions. Also, programs may comprise variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus, the invention should not be limited to use solely in any specific application identified and/or implied by such nomenclature.

While embodiments of the present invention are described below in reference to displaying change notifications to an electronic document having a predefined purpose regarding the status of components of a computer system, embodiments of the present invention may also be adapted for use with any electronic document having other predefined purposes. For instance, the system may be adapted for use in situations where the predefined purpose of an electronic document is to display search results, news updates or any other predefined purpose normally given to electronic documents.

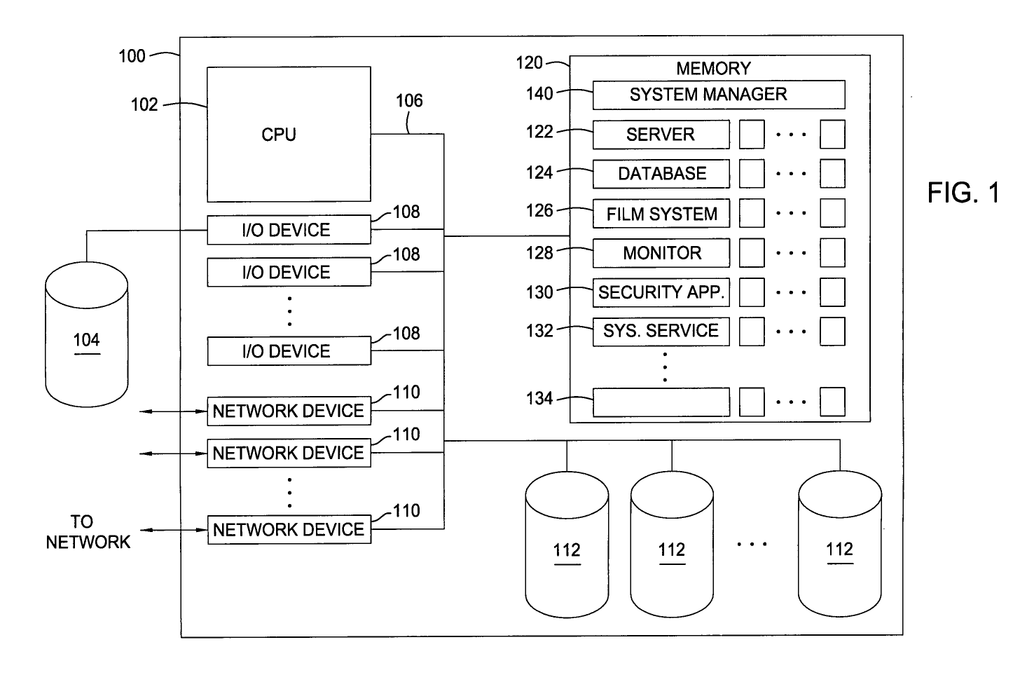

FIG. 1 is a block diagram illustrating an exemplary computer system 100 in which embodiments of the present invention may be implemented. The computer system 100 may contain a central processing unit (CPU) 102 for executing programs, a memory 120 for holding programs and data, Input/Output (I/O) devices 108, network devices 110, and storage drives 112 for long term storage of programs and data. Each of the devices in the system may be connected by a system bus 106. The system may also have a backup device 104 connected to one of the I/O devices 108. The memory 120 typically holds a copy of the programs being executed by the system. The programs being executed by the computer system may include a system manager program 140 and one or more servers 122, database programs 124, file systems 126, system monitors 128, security applications 130, system services 132, and other programs 134.

The system manager 140 may operate in the following manner. As each hardware or software component is installed on the system, the system manager 140 may detect and register the component. The system manager 140 may also be configured to assist in the installation of hardware and software components. The system manager 140 may then be utilized to track the status of each hardware and software component. The system manager 140 may track statuses in several ways.

The system manager 140 may periodically occasionally query each component to determine the status of the component through direct communication with the component or through a monitor program 128. A monitor program is a program which runs on a system and monitors some other component on the system. For instance, a system 100 may have a database monitor which monitors how well a database 124 is functioning by occasionally querying the database 124 and examining the results.

The system manager 140 may also track the status of a system 100 by receiving notifications from each of the components in the system. This may be referred to a push mechanism because the component is initiating (pushing) the change notification between the system manager 140 and the component. The component may initiate a communication with the system manager 140 by sending a notification to the system manager 140. The component may also initiate a communication with the system manager 140 by causing an interrupt to occur. The system manager 140 may be configured to detect the interrupt and communicate with the component in response to the interrupt.

For each component tracked by the system manager 140, the system manager 140 may create an electronic document which displays the status of that component. This electronic document may contain information such as the name of the component, the system address of the component, the manufacturer of the component, the status of the component and a list of subcomponents of the component along with links to a page containing similar information for each of the subcomponents.

The system manager 140 may also group each related component together according to a relationship among the components. For instance, the system manager 140 may provide an electronic document which displays the status of each of the servers 122 on the system. The system manager 140 may also provide an electronic document which displays all of the components which relate to a function of the system, such as querying and serving database information. Such an electronic document may contain the status of a server 122, a database 124, a storage device 112 on which database 124 info may be stored and other related components of the system 100. The system manager 140 may also provide a top level electronic document containing a general overview of the system status. For instance, this top level electronic document may have a listing of each major category of the components on the system (e.g., servers 122, storage 112, etc.) and may include links to electronic documents containing a listing of the components in that category. This top level electronic document may be provided as a starting page which may be displayed upon initialization of the system manager program 140.

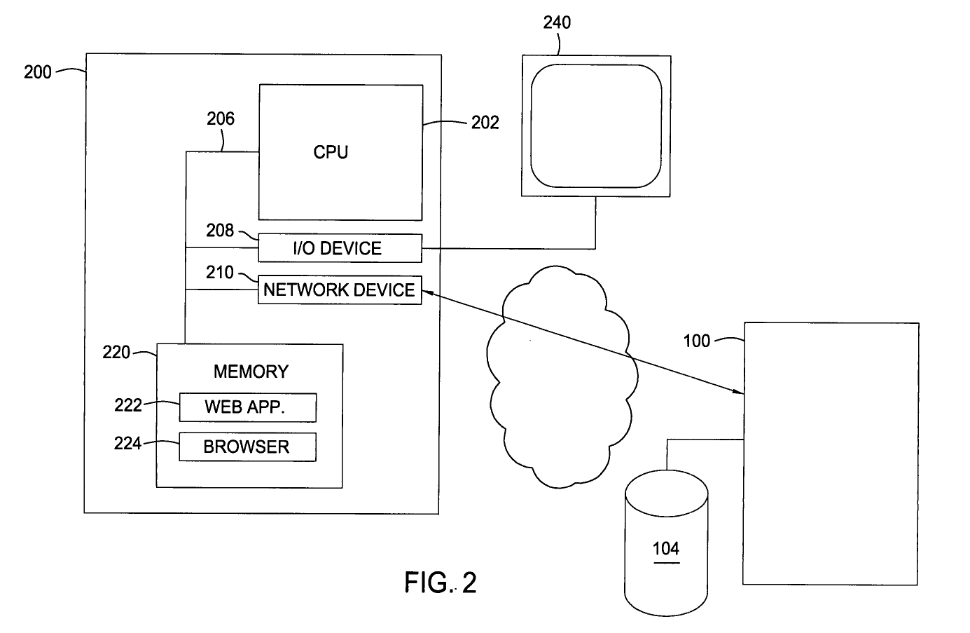

FIG. 2 is a block diagram illustrating an exemplary management computer system 200 configured for remote management of another computer system 100 according to one embodiment of the invention. The management computer system may contain a CPU 202, an input/output device 208, a network device 210, and a memory 220. Each device in the computer system 200 may be connected by a system bus 206. The memory of the management computer system 200 may contain a browser program 224 for browsing the network 250 and a web application 222 for handling the remote administration of the computer system 100. The management computer system 200 may also be connected to a display device 240 which displays results from the browser 224 and web application 222.

The computer system 100 may be remotely managed in the following manner. A user may open a browser program 224 on the management computer system 200 and use the browser program 224 to access the web application 222. The web application 222 may be installed from a disk provided by the manufacturer of the system manager 140 or may be downloaded from the manufacturer's web site. The web application 222 may also be downloaded from the system 100 being managed or may be obtained in any manner known to those skilled in the art. Furthermore, while the web application 222 is shown as being located on the local computer system 200, the web application 222 may, alternatively, be located on the computer being managed such as the computer system 100. A web application 222 located on the computer system 100 may be utilized to manage the computer system 100 by direct access.

According to one embodiment of the invention, the web application 222 may be used to manage the computer system 100 by connecting to the system 100 through a network 250. The network 250 may comprise a direct connection, a local area network (LAN), or a wide area network (WAN) such as the Internet. The network 250 may be accessed by an Ethernet card, a telephone modem, a cable modem, a wireless communication device, or any other network communication device known to those skilled in the art.

The system manager 140 may be accessed by the computer 200 in the following manner. The user of the computer system 200 may initiate the browser program 224 and access the web application 222. The user of the computer 200 may then request a connection to the remote computer 100, or the web application 222 may automatically initiate the connection. Upon connecting to the remote system 100, the web application 222 may request the start page (top level electronic document) for the system manager 140. The system manager 140 may deliver the start page (and all other electronic documents) directly to the web application 222. In an alternative embodiment, a server 122 on, the computer system 100 could be used by the web application 222 and the system manager 140 to communicate with each other.

The web application 222 may be used to query each electronic document provided by the system manager 140. Starting with the start page, the user may select links on the page which display electronic documents existing lower in the hierarchy of documents created by the system manager 140. The web application 222 may help a user keep track of how deep in the hierarchy the user is by showing a list of documents in the hierarchy indicating the path (e.g. bread crumbs) that the user has followed while following links down into the hierarchy. The web application 222 or browser 224 may also provide functionality allowing the user to save a link to a document in the hierarchy to a favorites folder. By saving a link to an electronic document located deep in the hierarchy, the user may be able to directly access that electronic document without having to begin at the start page and follow numerous links down to that document's location within the hierarchy.

Each of the electronic documents created by the system manager 140 may include a predefined purpose, as mentioned above. The purpose is predefined because the designer of the system manager 140 (which is used to create the electronic documents), not the user, selects and defines the purpose of the electronic document. For instance, the start page may have the predefined purpose of giving a general overview of the system health. Once the user has navigated away from the start page by selecting one of the links on that page, the user no longer sees the start page. Thus, if the status of the predefined purpose of the start page changes (i.e., if the system status changes), the user will be unaware of the change. Also, some electronic documents in the hierarchy may contain a listing of many components, not all of which are important to the user viewing that document. If the user wishes to determine the status of that document, the user may have to scan the entire document, looking for the pertinent components and determining their status. Thus, when accessing the system manager 140 using the web application 222 across the network 250, the user may need to download a large electronic document even though the user may only need to determine the status of a few components listed on that document.

Embodiments of the present invention provide a solution to this problem by allowing the user to determine whether there has been a change in the status of the predefined purpose of a document without having to download the entire document and scan each component listed in the document. Embodiments of the present invention also provide a method for notifying the user of changes in the status of the predefined purpose of an electronic document without requiring the user to constantly refresh and review the document. Furthermore, embodiments of the present invention are provided which allow for the user to be notified of changes to an electronic document located in the hierarchy above or below the document which the user is currently viewing. For example, when the user is viewing an electronic document which contains the status of the servers 122 on the system 100, the user may be notified of a change in the status of the status of the predefined purpose of the start page (i.e. a change in general system health). Additionally, embodiments of the present invention provide a method for notifying a user of changes in the status of the predefined purpose of an electronic document contained in a favorites folder.

According to one embodiment of the invention, the designer of an electronic document may provide a predefined purpose for that document. For instance, the designer may create a start page for the system manager 140 and decide that the predefined purpose of the start page will be general “system health”. The status of the predefined purpose may change from “good system health” to “bad system health” depending on the status of each of the components listed on the start page. Thus, for a start page which lists a server 122, a database 124 and a file system 126, if each of the components is functioning properly, then the predefined purpose of the start page may show that the system is in “good health”. If, however, a server 122 has crashed, the predefined purpose of the start page may change from “good system health” to “bad system health”.

The status of the predefined purpose of an electronic document may be determined in several manners. The electronic document may contain tags, such as hypertext markup language (HTML) or extensible markup language (XML) tags which contain a value for the predefined purpose of the page. The status of the predefined purpose of an electronic document may also be determined using the system manager 140 which may query the status of each of the important components listed in the electronic document.

The status of the predefined purpose of an electronic document may be calculated as a value or summary based on the status of each of the components which relate to the predefined purpose of the electronic document. To calculate the status of the predefined purpose of an electronic document, the system manager 140 may determine the status of each component in the document related to the predefined purpose of the document. For instance, the status of each component may be recorded as a binary number with “1” representing that the component is working and “0” representing that the component has failed. The system manager may read in each of the values for the components related to the predefined purpose of the document and perform a Boolean “AND” operation on the values. If a single component relating to the predefined purpose of a document has failed, the Boolean “AND” operation will return a “0” and the system manager 140 may return the “0” value representing that at least one component listed on the document has failed. If none of the components have failed, the Boolean “AND” operation will return a “1” and the system manager 140 may return the “1” value representing that no components have failed. More complicated operations may also be performed to determine the status of the predefined purpose, such as assigning a weight corresponding to the importance of each component with respect to the predefined purpose of the document and using the weight assigned to each component along with the component's status to calculate the status of the predefined purpose of the document.

The system manager 140 may also create a summary of the status of each component, and this resulting summary may be returned as the status of the predefined purpose of the document. The summary may be the simple value such as “good health” or “bad health” as mentioned above, or the summary may contain more information as detailed below. Also, as previously mentioned, each component listed in the electronic document may also have functionality which allows the component to notify the system manager 140 when a change in status has occurred, allowing the system manager 140 to then modify the status of the predefined purpose of the electronic document as needed.

In another embodiment, the electronic document may contain the results of a search performed in response to a submitted query, and the predefined purpose of such electronic document may comprise the search results. The search result electronic document may be saved, for example, as a bookmark in a bookmark or favorites list of the web application, and the web application may periodically refresh or re-submit the query to obtain a current set of search results. The web application may compare the current set of search results with the previous set of search results to determine whether the search results have changed. If the search results have changed, the predefined purpose is determined to have been changed also, and a notification indicating that the predefined purpose (i.e., the search results) have changed may be provided to the user, for example, utilizing a notification image displayed next to the respective bookmark in the bookmark/favorites list.

As another example, the predefined purpose for an electronic document may comprise a news article or a news page. The web application may periodically determine whether the news article or the news page has been updated, and if so, provide a notification to the user.

Determination of the status of the predefined purpose of an electronic document may be handled by a different program than the system manager 140. For instance, in one contemplated embodiment of the present invention, the system manager 140 may keep each electronic document up to date while a server 122 may provide functionality for parsing the electronic document and determining the value of that document's predefined purpose status. Also, based on the contemplated embodiments disclosed above, other possible embodiments of the invention in which the status of the predefined purpose of an electronic document is determined in a different manner should be readily apparent to those skilled in the art.

Determination of whether there has been a change in the status of the predefined purpose of a page may be handled in several ways according to different embodiments of the present invention. In one embodiment of the present invention, the change may be detected by the web application 222. For instance, the web application may keep track of the predefined purpose of an electronic document by periodically contacting a server 122 located on the remote system 120 and requesting the predefined purpose for an electronic document. The server 122 may then request the status of the predefined purpose of the electronic document from the system manager 140. As mentioned above, in another embodiment of the invention, a server 122 may determine the status of the predefined purpose of an electronic document without consulting the system manager 140, or, as an alternative to using a special server 122, the web application 222 may directly contact the system manager 140 for the status of the predefined purpose of an electronic document.

Once the status of the predefined purpose of the electronic document has been determined, the value may be returned across the network 250 to the web application 222. The retuned value of the status of the predefined purpose may be stated as a simple “yes” or “no” (e.g., “yes” when the system is in good health or “no” when the system is not in good health), or the status of the predefined purpose of an electronic document may be stated in a short summary. For example, the returned value may be a number such as “87” which notifies the web application that the computer system 100 is working at 87% of its maximum capacity. If the web application 222 queries the remote computer system 100 regarding an electronic document whose predefined purpose is the status of a system component (e.g., a storage device 112), the return value for the status of the predefined purpose may be a single-word summary such as “functioning” or “failed” (e.g., the storage device is “functioning” properly or the storage device has “failed”). The summary may also be stated as a message which may be relayed to the user, such as “Hardware device 20 has failed.” Finally, the response from the computer system 100 may also contain a computer image or icon for use in displaying a notification to a user of the web application 222. For instance, if an electronic document shows that a component has “failed”, the response may contain an image of an exclamation mark which, when displayed to the user, may notify the user that the component is in need of attention.

When the web application 222, by periodic polling of the computer system 100, determines that the status of the predefined purpose for a page has changed, the web application 222 may notify the user. The web application 222 may notify the user of the change by playing a sound on the system and/or displaying the result of the predefined purpose query (i.e., the status, text, or image listed above) through a browser 224, a popup and/or any of the normal system features known to those skilled in the art. The web application 222 may also send the user an email, an alphanumeric page and/or a voicemail message containing the results regarding the status of the predefined purpose of the electronic document.

In one embodiment, when a user sees that the predefined purpose of an electronic document has changed or that a particular component needs attention, the user may click on or otherwise select the link having the notification image to display the details of the change or the details regarding the particular component that needs attention. Thus, embodiments of the invention provide the advantage/benefit that a user may quickly determine that a predefined purpose of an electronic document has changed and immediately view the details of the change, for example, by a single click on a link in a breadcrumb or a bookmark.

According to another embodiment of the invention, the web application 222 may determine that there has been a change in the status of the predefined purpose of a document by querying the computer system 100 with a query containing a request regarding the predefined purpose of an electronic document and a timestamp corresponding to the last time the user viewed the electronic document. The server 122 may then use the timestamp to determine if the status of the predefined purpose of the electronic document has changed since the last time the user viewed the document (as given by the timestamp) and return a simple “yes” or “no” signifying that the status of the predefined purpose has changed or the status of the predefined purpose has not changed, respectively.

A request for the whether the status of the predefined purpose of a page has changed may, for instance, be sent by the web application 222 in the form of a Uniform Resource Locator (URL). For instance, the URL for the document may contain a first parameter specifying that the predefined purpose is being queried and a second parameter specifying the timestamp, as shown below:
http://www.myserver.com/system/servers.html?request=predefpurp&time=010104
The above URL may correspond to a request for the status of the servers 122 (“servers.html”) on a computer system 100 (“myserver.com”). The request parameter is “predefpurp” (short for “predefined purpose”), and the timestamp is a date (“010104”) corresponding to the last day the page was visited, Jan. 1, 2004. The timestamp may also be more specific, for instance, by listing time parameters such as date, hour, minute and second for the previous time the page was visited. The electronic document may include an attribute (e.g., a primary predefined purpose attribute or key intent attribute) which includes the “predefpurp” and timestamp values. The attribute may be in the form of a field, a parameter, an HTML tag, an XML tag, or other forms of tags. In response to the request, the values contained in this attribute of the electronic document may be returned to the web application 222. In another embodiment, the system containing the electronic document may provide the values of the attribute to the web application 222 periodically or upon a change to the value of the primary predefined purpose.

The web application 222 may be notified of a change in the status of the predefined purpose of an electronic document using a push technology. A push technology, may, for example, comprise a notification packet sent from the computer system 100 to a port (a port is a connection to the internet) on which the web application 222 is listening. In one embodiment, the notification packet may be sent periodically by the computer system 100 to the web application 222. In another embodiment, such notification packet may be initiated, for example, by the failure of a hardware component on the computer system 100. For instance, a storage device 112 may fail and cause an interrupt to occur. The system manager 140 may detect the interrupt, update the electronic document which displays the status of the storage device 112, and communicate a notification of the change in the status of the predefined purpose of that electronic document to a server 122. The server 122 may take the notification of the change, create a notification packet and send the notification packet to the port on the remote computer 200 on which the web application 222 is listening. Upon receiving the notification packet, the web application 222 may then notify the user of the change to the status of the predefined purpose of the electronic document.

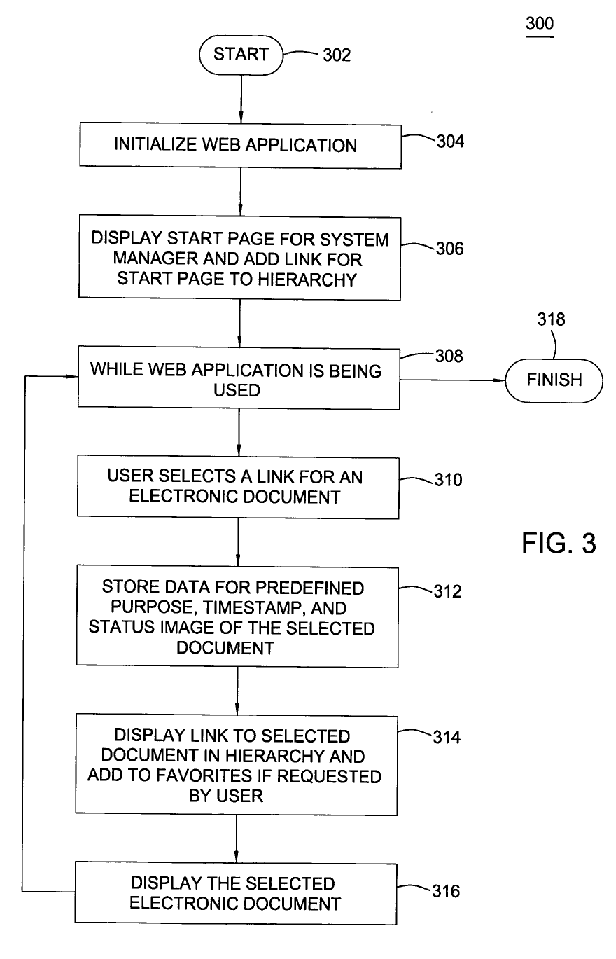

FIG. 3 is a flow diagram illustrating a process 300 for displaying electronic documents according to one embodiment of the invention. The process begins at step 302 and continues to step 304 where the web application 222 is initialized. The process continues to step 306 where the start page is displayed and a link for the start page is added to the hierarchy. At step 308 the process enters a loop that continues while the web application 222 is being used. When the user selects a link for another electronic document at step 310 the web application 222 stores the status of the predefined purpose, which may include a summary of the pieces of data in the document corresponding to the predefined purpose, a timestamp, and a status image for the selected document (step 312). The process may then display a link to the selected document in the hierarchy view and add the selected document to a favorites list if requested by the user at step 314. At step 316 the selected electronic document is displayed and the web application 222 continues the loop beginning at step 308 until the program finishes at step 318.

According to one embodiment of the invention, documents may be displayed in the document hierarchy or a navigation trail in the following manner. For each document that the user has visited, information (commonly referred to as a breadcrumb) may be added to a data structure representing the hierarchy. This information may include the name of the electronic document, a link to the electronic document, a timestamp corresponding to the last time the electronic document was visited and an image for displaying the status of the status of the predefined purpose of the electronic document. As the user selects links which drill down into the hierarchy, each selected link may be added as a breadcrumb in the hierarchy (step 310). Likewise, as a user moves back up the hierarchy of documents, the breadcrumb and link for the document being exited may be removed from the hierarchy. If a user requests that an electronic document link be added to the user's favorites list, the breadcrumb and associated data may similarly be added to a data structure representing the favorites list. Although embodiments of the invention are described herein in relation to bread crumbs (or navigation trails) and favorites dialog box, other forms of implementation are contemplated, such as, a hierarchical tree window, a favorites/bookmark list, a portlet or window, an area/icon on the desktop of an operating system, or other forms of displays.

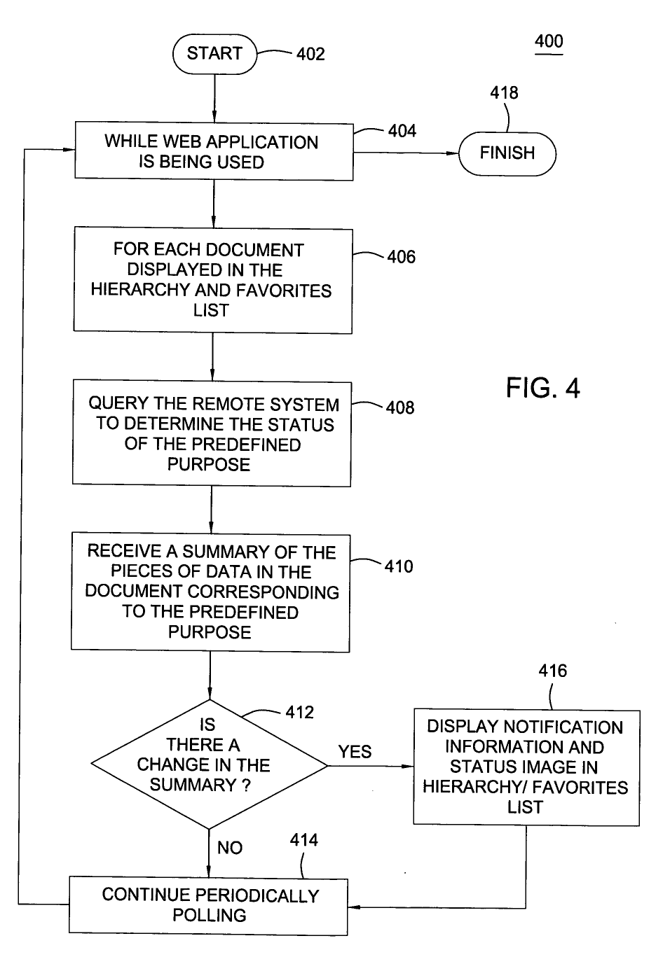

FIG. 4 is a flow diagram illustrating a process 400 for displaying a change notification according to one embodiment of the invention. The process 400 may be executed concurrently by the web application 222 with the process 300 for displaying electronic documents such that the hierarchy view and favorites view are always kept up to date while a user is browsing through documents using the process 300 described in FIG. 3. The process 400 for displaying a change notification begins at step 402 and continues to step 404 where the web application 222 enters a loop which continues while the application 222 is being used. For each document displayed in the hierarchy list and favorites list (step 406), the web application 222 queries the remote system to determine the status of the predefined purpose for that electronic document. At step 410 the web application 222 receives a response containing a summary of the pieces of data in the electronic document corresponding to the predefined purpose of the document. If the web application 222 determines that there has been a change in the summary of the pieces of data corresponding to the predefined purpose of the document (step 412), the web application 222 displays a notification along with the status image for the predefined purpose at step 416. The web application 222 will continue to periodically poll each document's predefined purpose (step 414) while the web application 222 is being used (step 404). Alternatively, statuses of the electronic document's predefined purpose may be periodically provided by the system containing the electronic document utilizing push technologies described herein. Once the web application 222 is exited, the process may finish at step 418.

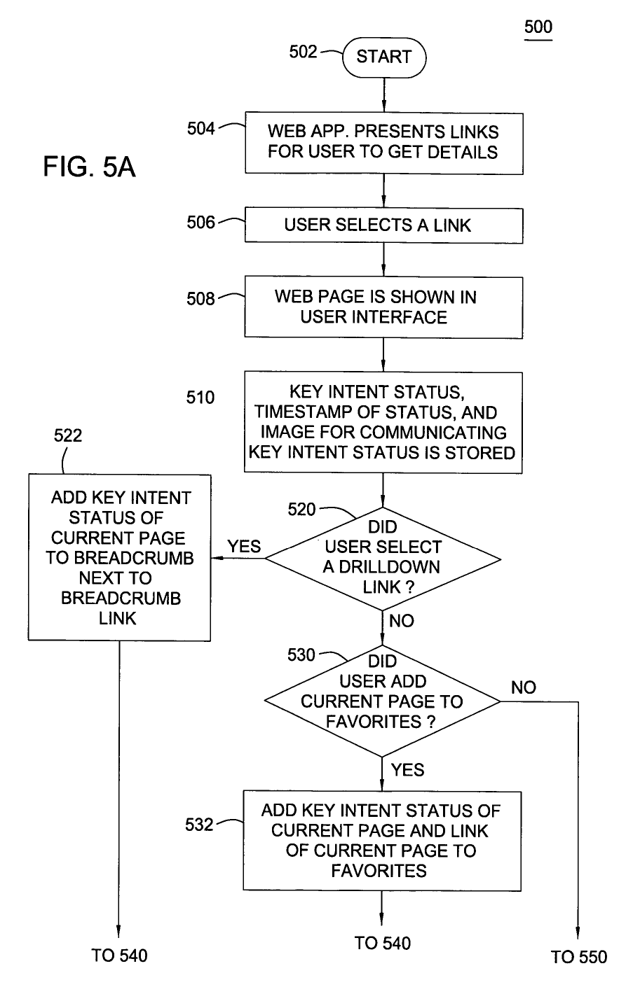

FIG. 5 is a flow diagram illustrating a process 500 for displaying changes to the key intent status (i.e., status of the predefined purpose) of a link according to one embodiment of the invention. The process 500 may begin at step 502 and may continue to step 504 where the web application 222 may present links to the user which allow the user to get details regarding the current page. At step 506, the user may select a link and at step 508 the web page for that link may be shown to the user in the user interface. At step 510, the key intent status, the timestamp of the status and any images for communicating the key intent status may be stored. At step 520, the web application 222 may determine if the user has selected a drilldown link. If a drilldown link has been selected, the key intent status of the current page may be added as a breadcrumb next to the breadcrumb link (step 522). If the user has not selected a drilldown link, the web application 222 may determine at step 530 whether the user has added the current page to the user's favorites list. If the current page has been added to the user's favorites list, the key intent status of the current page as well as a link to the current page may be added to the user's favorites list at step 532. However, if the current page is not added to the user's favorites list, the process 500 may terminate at step 550.

In one embodiment, the page or electronic document may have more than one key intents or predefined purposes, and the user may be provided with an option to select one or more particular key intents or predefined purposes of interest when a link to the electronic document is being saved in a favorites list or a bookmark list. In such cases, a plurality of key intent statuses may be tracked and displayed along with the saved/bookmarked link.

At a predetermined time interval (step 540), the web application 222 may query the link for changes to the key intent using the stored key intent status and the timestamp. The server 130, in response to the query, may pass back a new key intent status to the web application 222 at step 542. Alternatively, key intent statuses of the electronic document may be periodically provided by the system containing the electronic document utilizing push technologies described herein. The web application 222 may then show the new key intent status next to the link at step 544. At step 546, the web application may determine if the key intent status is still needed. The key intent status may be needed as long as the link is still visible to the user in the user interface. If the key intent status is still needed, the web application 222 may continue querying the link for changes to the key intent status (step 540). If the key intent status is no longer needed, the process 500 may finish at step 550.

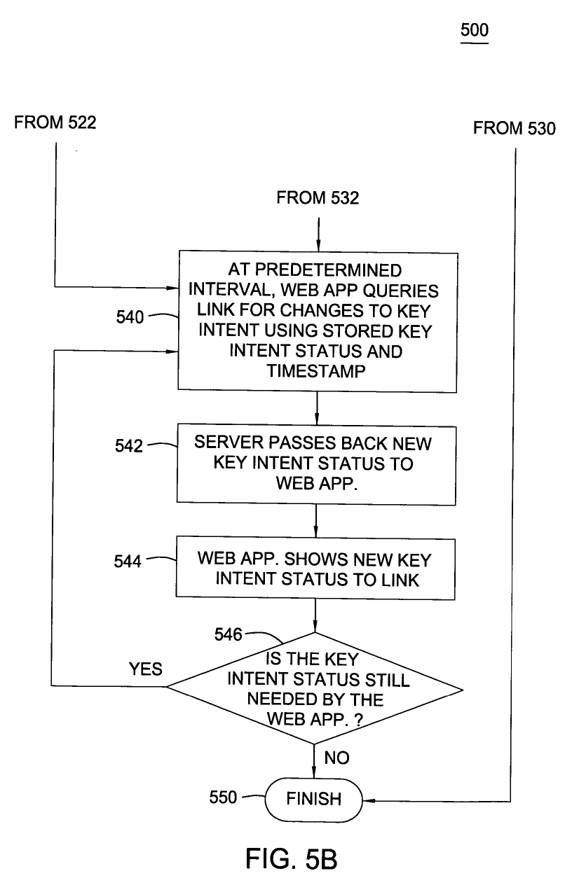

FIG. 6 is a diagram illustrating an exemplary user interface 600 for displaying changes to the predefined purpose of an electronic document in a hierarchy according to one embodiment of the invention. The user interface 600 may contain a hierarchy view with several links 602, 604, 606, and 608. Each link represents a level in the document hierarchy that the user has visited. For instance, the user may have started at a start page, so the first link displayed in the hierarchy is a link to the start page 602. Accordingly, the user may have browsed down the hierarchy from the start page link 602, to a hardware page link 604, to a storage page link 606 and finally to a drive page link 608 for “Drive 20”, which the user is currently viewing. When the user browses through each page, a breadcrumb may be added to the hierarchy which lists the status of the predefined purpose for each page along with a link to each page 602, 604, 606, 608.

At some point since the user last visited the hardware page link 604, a piece of hardware may have failed, causing the status of the predefined purpose for the hardware page (i.e. the health of all of the system hardware) to change from normal to requiring attention. Thus, the web application 222, which periodically queries the predefined purpose for that page, may detect the change in the status of the predefined purpose. The web application 222 may download and display a notification image 620 such as an exclamation point, corresponding to the change in the status of the predefined purpose for the hardware link 604. Thus, the user may be notified by the notification image 620 that the hardware page needs attention because the status of the predefined purpose of that page has changed.

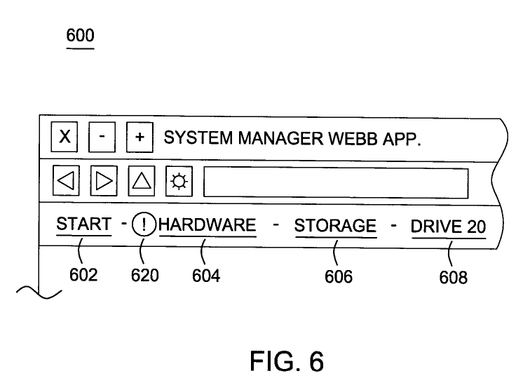

FIG. 7 is a diagram illustrating an exemplary user interface 700 for displaying changes to the status of the predefined purpose of an electronic document in a favorites folder according to one embodiment of the invention. Links to an electronic document may be added to a favorites dialog box 730 by allowing for the user to drag and drop icons into the folder, by allowing the user to right click the link and select an “Add to Favorites” option from a contextual pop-up menu, by selecting an option from a pull down menu, or by any other method known to those skilled in the art. The favorites dialog box 730 may be subdivided into folders 702 by either a developer of the dialog box 730 or a user. For instance, the favorites dialog may contain a “System Manager” folder 710 to which a user may have added a link to a hardware page 704, software page 706, or some other page 708.

At some point since the user last visited the hardware page link 604, a piece of hardware may have failed, causing the status of the predefined purpose for the hardware page (i.e., the health of all of the system hardware) to change from normal to requiring attention. Thus, the web application 222, which periodically queries the predefined purpose for that page, may detect the change in the status of the predefined purpose. The web application 222 may download and display in the favorites dialog 730 a notification image 620 such as an exclamation point corresponding to the change in the status of the predefined purpose for the hardware link 604. Thus, the user may be notified by the notification image 620 that the hardware page needs attention because the status of the predefined purpose of that page has changed.

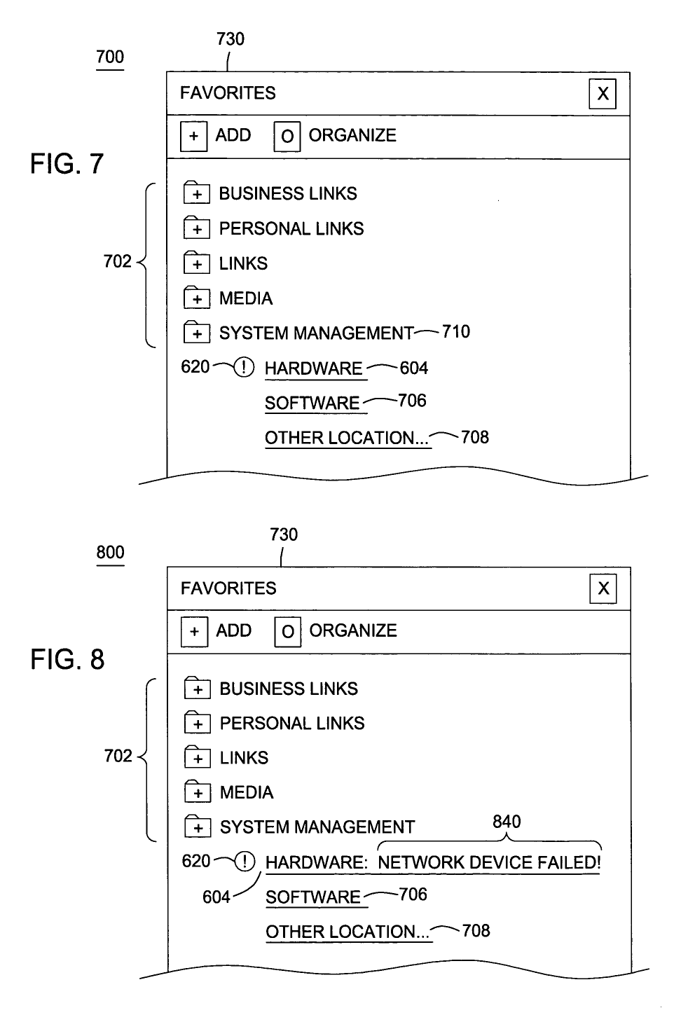

FIG. 8 is a diagram illustrating an exemplary user interface 800 for displaying changes to the status of the predefined purpose of an electronic document in a favorites folder according to another embodiment of the invention. Again, an exemplary favorites dialog box 730 is pictured. At some point since the user last visited the hardware page link 604, a piece of hardware may have failed, causing the status of the predefined purpose for the hardware page (i.e., the health of all of the system hardware) to change from normal to requiring attention. The web application 222 which periodically queries the status of the predefined purpose for that page may detect the change in the predefined purpose. The web application 222 may download and display in the favorites dialog 730 a notification image 620 such as an exclamation point corresponding to the change in the predefined purpose for the hardware link 604. In addition, the web application may download a string containing the status of the predefined purpose of the page 840 which notifies the user that a network device has failed. Thus, the user may be notified by the notification image 620 that the hardware page needs attention because the status of the predefined purpose of that page has changed, and the user may be further notified that the reason for the change is the failure of a network device. Accordingly, the user may know the status of the predefined purpose of the page without having to visit the page.

While the foregoing is directed to embodiments of the present invention, other and further embodiments of the invention may be devised without departing from the basic scope thereof, and the scope thereof is determined by the claims that follow.

What is claimed is:

1. A computer implemented method for monitoring changes to an electronic document having a primary predefined purpose, the method comprising:
accessing an attribute of the electronic document, wherein the attribute is specifically and solely configured to reflect the primary predefined purpose of the electronic document;
determining whether the attribute indicates that a status of the primary predefined purpose has changed; and
displaying a change notification when the status of the primary predefined purpose has changed.

2. The method of claim 1, wherein the attribute comprises a status and an associated time stamp and wherein the determining step comprises:
storing a first status of the primary predefined purpose of the electronic document and a first associated time stamp;
receiving a second status of the primary predefined purpose and a second associated time stamp; and
comparing the first status and the second status.

3. The method of claim 2, wherein the accessing step comprises:
querying the electronic document for the attribute, wherein the second status is received in response to the query.

4. The method of claim 1, wherein the respective attribute of the respective electronic document remains unchanged while one or more parts of the respective electronic document have changed.

5. The method of claim 1, wherein the primary predefined purpose of the electronic document comprises a group of statuses corresponding to a group of components listed in the electronic document and wherein the status of the primary predefined purpose of the electronic document is determined by assessing whether the components listed in the electronic document are functioning.

6. The method of claim 1, wherein the attribute comprises one of a field, a parameter, an HTML tag and an XML tag.

7. The method of claim 1, wherein the electronic document is located on a remote computer and wherein the attribute is determined and provided periodically by the remote computer.

8. The method of claim 1, wherein displaying the change notification comprises:
downloading at least one of an image and a text string corresponding to the status of the primary predefined purpose; and
displaying the at least one downloaded image and text string to the user.

9. The method of claim 8, further comprising:
providing a hierarchical view of a plurality of previously viewed electronic documents and a currently viewed electronic document, wherein the change notification is displayed to the user in the hierarchical view of the plurality of electronic documents.

10. The method of claim 8, wherein the change notification is displayed to the user in at least one of a favorites dialog box, a bookmark list, a desktop area and a status window.

11. A computer readable medium containing a program which, when executed, performs an operation, comprising:
accessing an attribute of an electronic document having a primary predefined purpose, wherein the attribute is specifically and solely configured to reflect the primary predefined purpose of the electronic document;
determining whether the attribute indicates that a status of the primary predefined purpose has changed; and
displaying a change notification when the status of the primary predefined purpose has changed.

12. The computer readable medium of claim 12, wherein the attribute comprises a status and an associated time stamp and wherein the determining step comprises:
storing a first status of the primary predefined purpose of the electronic document and a first associated time stamp;
receiving a second status of the primary predefined purpose and a second associated time stamp; and
comparing the first status and the second status.

13. The computer readable medium of claim 12, wherein the accessing step comprises:
querying the electronic document for the attribute, wherein the second status is received in response to the query.

14. The computer readable medium of claim 11, wherein the respective attribute of the respective electronic document remains unchanged while one or more parts of the respective electronic document have changed

15. The computer readable medium of claim 11, wherein the primary predefined purpose of the electronic document comprises a group of statuses corresponding to a group of components listed in the electronic document and wherein the status of the primary predefined purpose of the electronic document is determined by assessing whether the components listed in the electronic document are functioning.

16. The computer readable medium of claim 11, wherein the attribute comprises one of a field, a parameter, an HTML tag and an XML tag.

17. The computer readable medium of claim 11, wherein the electronic document is located on a remote computer and wherein the status of the primary predefined purpose is determined and provided periodically by the remote computer.

18. The computer readable medium of claim 11, wherein displaying the change notification comprises:
downloading at least one of an image and a text string corresponding to the status of the primary predefined purpose; and
displaying the at least one downloaded image and text string to the user.

19. The computer readable medium of claim 11, wherein the operation further comprises:
providing a hierarchical view of a plurality of previously viewed electronic documents and a currently viewed electronic document, wherein the change notification is displayed to the user in the hierarchical view of the plurality of electronic documents.

20. The computer readable medium of claim 11, wherein the change notification is displayed to the user in at least one of a favorites dialog box, a bookmark list, a desktop area and a status window.

21. A system containing a memory and a processor, the memory containing a program which, when executed by the processor, performs an operation, comprising:
accessing an attribute of an electronic document having a primary predefined purpose, wherein the attribute is specifically and solely configured to reflect the primary predefined purpose of the electronic document;
determining whether the attribute indicates that a status of the primary predefined purpose has changed; and
displaying a change notification when the status of the primary predefined purpose has changed.

22. The system of claim 21, wherein the attribute comprises a status and an associated time stamp and wherein the determining step comprises:
storing a first status of the primary predefined purpose of the electronic document and a first associated time stamp;
receiving a second status of the primary predefined purpose and a second associated time stamp; and
comparing the first status and the second status.

23. The system of claim 22, wherein the accessing step comprises:
querying the electronic document for the attribute, wherein the second status is received in response to the query.

24. The system of claim 21, wherein the respective attribute of the respective electronic document remains unchanged while one or more parts of the respective electronic document have changed

25. The system of claim 21, wherein the primary predefined purpose of the electronic document comprises a group of statuses corresponding to a group of components listed in the electronic document and wherein the status of the primary predefined purpose of the electronic document is determined by assessing whether the components listed in the electronic document are functioning.

26. The system of claim 21, wherein the attribute comprises one of a field, a parameter, an HTML tag and an XML tag.

27. The system of claim 21, wherein the electronic document is located on a remote computer and wherein the status of the primary predefined purpose is determined and provided periodically by the remote computer.

28. The system of claim 21, wherein displaying the change notification comprises:
downloading at least one of an image and a text string corresponding to the status of the primary predefined purpose; and
displaying the at least one downloaded image and text string to the user.

29. The system of claim 21, wherein the operation further comprises:
providing a hierarchical view of a plurality of previously viewed electronic documents and a currently viewed electronic document, wherein the change notification is displayed to the user in the hierarchical view of the plurality of electronic documents.

30. The system of claim 21, wherein the change notification is displayed to the user in at least one of a favorites dialog box, a bookmark list, a desktop area and a status window.

31. A computer implemented method for monitoring changes to a plurality of previously accessed electronic documents, each having a predefined primary purpose attribute, comprising:
displaying a hierarchical link representation having a plurality of links corresponding to the plurality of the previously accessed electronic documents;
determining whether respective primary predefined purpose attribute of respective previously accessed electronic document has changed; and
displaying a change notification with the respective link in the hierarchical link representation when the respective primary predefined purpose attribute has changed for the respective previously accessed electronic document.

32. The method of claim 31, further comprising:
for each electronic document, when first accessed, storing a first primary predefined purpose attribute of the respective previously accessed electronic document; and
comparing a subsequently-received primary predefined purpose attribute of the respective previously accessed electronic document to determine whether the primary predefined purpose attribute has changed.

33. The method of claim 32, further comprising:
querying the electronic document for the subsequently-received primary predefined purpose attribute.

34. The method of claim 32, wherein the subsequently-received primary predefined purpose attributes is received from and determined by a remote computer system containing the electronic document.

35. The method of claim 31, wherein the respective primary predefined purpose attribute of the respective electronic document remains unchanged while one or more parts of the respective electronic document have changed.

36. The method of claim 31, wherein each primary predefined purpose attribute comprises one of a field, a parameter, an HTML tag and an XML tag.

37. The method of claim 31, wherein displaying the change notification comprises:
downloading at least one of an image and a text string corresponding to the primary predefined purpose attribute; and
displaying the at least one downloaded image and text string in the hierarchical link representation.

38. The method of claim 31, wherein the hierarchical link representation comprises a navigational trail.

39. The method of claim 31, further comprising:
selecting the respective link in the hierarchical link representation for which the respective primary predefined purpose attribute has changed; and
displaying an updated version of the respective previously accessed electronic document.
